(19) United States
(12) Patent Application Publication
(10) Pub. No.: US 2026/0119241 A1
(43) Pub. Date: Apr. 30, 2026

(54) MEMORY ALLOCATION METHOD AND APPARATUS IN DATA QUERY

(71) Applicant: Beijing Volcano Engine Technology Co., Ltd., Haidian District (CN)

(72) Inventor: Guangnan He, Beijing (CN)

(21) Appl. No.: 19/364,680

(22) Filed: Oct. 21, 2025

(30) Foreign Application Priority Data
Oct. 29, 2024 (CN) 202411525009.4

(51) Int. Cl. G06F 9/50

(52) U.S. Cl. CPC G06F 9/5016

(57) ABSTRACT

The present application discloses a memory allocation method in data query. The method includes: receiving a data query request; allocating first memory by using a target memory allocator and allocating second memory by using a general-purpose memory allocator according to the data query request, wherein the first memory is used for creating an object of a specific type, the second memory is used for creating objects of other types, and the other types are types other than the specific type; wherein: the first memory is greater than the second memory, the target memory allocator and the general-purpose memory allocator are different, and the target memory allocator pre-allocates virtual memory at an initialization stage.

### CROSS-REFERENCE TO RELATED APPLICATIONS

The present disclosure claims the priority from the CN patent application No. 202411525009.4 entitled “Memory allocation method and apparatus in data query” filed with the China National Intellectual Property Administration (CNIPA) on October 29, 2024, the contents of which are hereby incorporated by reference in their entirety.

### FIELD

The present application relates to the field of software, and in particular, to a memory allocation method and apparatus in data query.

### BACKGROUND

At present, a database may support a data query. When receiving a data query request, the database may apply for a memory from an operating system (Operating System, OS) to facilitate processing the data query request by using the applied memory.

### SUMMARY

The present application provides a memory allocation method and apparatus in data query.

According to a first aspect, the present application provides a memory allocation method in data query, the method including: receiving a data query request; allocating first memory by using a target memory allocator and allocating second memory by using a general-purpose memory allocator according to the data query request, wherein the first memory is used for creating an object of a specific type, the second memory is used for creating objects of other types, and the other types are types other than the specific type; wherein: the first memory is greater than the second memory, the target memory allocator and the general-purpose memory allocator are different, and the target memory allocator pre-allocates virtual memory at an initialization stage.

Optionally, the allocating the first memory by using the target memory allocator includes: allocating target virtual memory from the pre-allocated virtual memory; allocating the first memory based on the target virtual memory.

Optionally, the method is applied to a server, the server is integrated with a memory allocation service, and the method further includes: initializing the memory allocation service in response to the server being started, wherein initializing the memory allocation service includes: compiling the memory allocation service, and allocating the virtual memory for the target memory allocator when the memory allocation service is in a compilation stage.

Optionally, the object of the specific type includes one or more of the following: a hash table, a plain of data array, or a data structure including a linked list.

Optionally, the objects of the other types include one or more of the following: a pipeline executor, a thread pool, a data column, a string, a vector, or a map.

Optionally, a page corresponding to the virtual memory is obtained by segmenting the virtual memory by using a huge page technology.

Optionally, the general-purpose memory allocator includes: Jemalloc or Tcmalloc.

According to a second aspect, the present application provides a memory allocation apparatus in data query, the apparatus including: a receiving unit, configured to receive a data query request; an allocating unit, configured to allocate first memory by using a target memory allocator and allocate second memory by using a general-purpose memory allocator according to the data query request, wherein the first memory is used for creating an object of a specific type, the second memory is used for create objects of other types, and the other types are types other than the specific type; wherein: the first memory is greater than the second memory, the target memory allocator and the general-purpose memory allocator are different, and the target memory allocator pre-allocates virtual memory at an initialization stage.

Optionally, the allocating unit is configured to: allocate target virtual memory from the pre-allocated virtual memory; allocate the first memory based on the target virtual memory.

Optionally, the apparatus is applied to a server, the server is integrated with a memory allocation service, and the apparatus further includes: an initializing unit, configured to initialize the memory allocation service in response to the server being started, wherein initializing the memory allocation service includes: compiling the memory allocation service, and allocating the virtual memory for the target memory allocator when the memory allocation service is in a compilation stage.

Optionally, the object of the specific type includes one or more of the following: a hash table, a plain of data array, or a data structure including a linked list.

Optionally, the objects of the other types include one or more of the following: a pipeline executor, a thread pool, a data column, a string, a vector, or a map.

Optionally, a page corresponding to the virtual memory is obtained by segmenting the virtual memory by using a huge page technology.

Optionally, the general-purpose memory allocator includes: Jemalloc or Tcmalloc.

According to a third aspect, an embodiment of the present application provides an electronic device, the electronic device including a processor and a memory; the processor is configured to execute instructions stored in the memory to cause the electronic device to perform the method according to any one of the above first aspect.

According to a fourth aspect, an embodiment of the present application provides a computer-readable storage medium including instructions, the instructions instructing a device to perform the method according to any one of the above first aspect.

According to a fifth aspect, an embodiment of the present application provides a computer program product that, when running on a computer, causes the computer to perform the method according to any one of the above first aspect.

### BRIEF DESCRIPTION OF THE DRAWINGS

In order to more clearly illustrate the technical solutions in the embodiments of the present application or in the prior art, the following briefly introduces the drawings required for describing the embodiments or the prior art. Apparently, the drawings in the following description show merely some embodiments of the present application, and a person of ordinary skill in the art may still derive other drawings from these drawings without creative efforts.

FIG. 1 is a flowchart of a memory allocation method in data query according to an embodiment of the present application;

FIG. 2 is a flowchart of a memory allocation method according to an embodiment of the present application;

FIG. 3 is a schematic diagram of a structure of a memory allocation apparatus in data query according to an embodiment of the present application;

FIG. 4 is a schematic diagram of a structure of an electronic device according to an embodiment of the present application.

### DETAILED DESCRIPTION OF EMBODIMENTS

In order to enable a person skilled in the art to better understand the solutions of the present application, the following clearly and comprehensively describes the technical solutions in the embodiments of the present application with reference to the drawings in the embodiments of the present application. Apparently, the described embodiments are merely a part rather than all of the embodiments of the present application. All other embodiments obtained by a person of ordinary skill in the art based on the embodiments in the present application without creative efforts shall fall within the protection scope of the present application.

At present, when the database applies for the memory from the operating system, a general-purpose memory allocator may be used to allocate the memory. However, when the general-purpose memory allocator is used to allocate the memory, the performance of memory allocation is poor.

Therefore, a solution is urgently needed to solve the above problem.

The inventors of the present application have found through research that when receiving a data query request, a database may apply for a memory from an operating system to facilitate processing the data query request by using the applied memory. At present, the memory may be allocated by a system memory allocator provided by the operating system. However, the performance of the memory allocator provided by the operating system is relatively poor, which often affects the processing efficiency of the data query request. Therefore, a general-purpose memory allocator with better performance may be selected to allocate the memory. For example, one of the two general-purpose memory allocators, that is, Jemalloc and Tcmalloc, is selected to allocate the memory.

The general-purpose memory allocator has good performance when allocating a relatively small memory. In the scenario where it is necessary to allocate a relatively large memory, the performance of the general-purpose memory allocator cannot meet the requirement, which may be specifically embodied in that the page fault phenomenon and the TLB miss phenomenon are both relatively serious, and moreover, a large amount of memory fragmentation may be caused. In the execution process of a data query task, it is often necessary to apply for a relatively large memory. For example, in the vectorization execution process, data of each column is stored in the memory by using an array with a length of 64 kilobytes (k). In the execution process of operators such as a common aggregation and a join, a large amount of memory needs to be applied for to construct a hash table.

Therefore, in the data query task, the performance of the general-purpose memory allocator for allocating the memory cannot meet the requirement.

In order to solve the above problem, embodiments of the present application provide a memory allocation method and apparatus in data query.

Compared with the prior art, embodiments of the present application have the following advantages:

The present application provides a memory allocation method in data query. The method includes: receiving a data query request, wherein a process of processing the data query request requires creating an object of a specific type and objects of other types in a memory, wherein the objects of the other types refer to other objects other than the object of the specific type. A difference between the object of the specific type and the objects of the other types lies in that memories required for creating the two are different. Specifically, the memory occupied for creating the object of the specific type is greater than the memory occupied for creating the objects of the other types. In the present application, for the object occupying a relatively small memory (that is, the objects of the other types), a general-purpose memory allocator is used to allocate second memory so as to subsequently create the object occupying the relatively small memory based on the second memory. For the object occupying a relatively large memory (that is, the object of the specific type), instead of using the general-purpose memory allocator to allocate the memory, a target memory allocator is used to allocate first memory so as to subsequently create the object of the specific type based on the first memory. The target memory allocator pre-allocates virtual memory at an initialization stage. Therefore, allocating the first memory based on the target memory allocator can effectively reduce page fault and translation lookaside buffer (TLB) miss so as to improve the performance of memory allocation. Moreover, by using the solution, memory fragmentation can also be effectively reduced. Therefore, by using the solution, the performance of memory allocation can be improved.

Before introducing the solution provided by the embodiments of the present application, related concepts involved in the present application are introduced.

### Physical memory

The physical memory refers to the memory that actually exists in the computer, and for example, may be composed of a random access memory (Random Access Memory, RAM) and directly managed by computer hardware. The size of the physical memory is fixed and depends on the configuration of the computer hardware.

### Virtual memory

The virtual memory is an abstract concept provided by an operating system. The size of the virtual memory is configurable and may be adjusted according to settings of the operating system and application requirements.

### Page fault

Page fault refers to that when a page in a virtual address space corresponding to virtual memory is accessed, if the page is not currently corresponding to a page of the physical memory, a page fault signal is generated.

### TLB miss

The basic unit stored in the TLB is a page (page) entry, which corresponds to a page entry stored in the physical memory (e.g., RAM). The size of the page entry stored in the TLB is fixed. Therefore, the larger the capacity of the TLB is, the more page entries can be stored, and the greater the probability of TLB hit is. Once the page entry in the physical memory fails to hit the page entry in the TLB, a TLB miss occurs.

### Memory fragmentation

As the name implies, the memory fragmentation may be understood as fragmented memory, that is, the memory with a relatively small capacity. In the present application, the memory fragmentation refers to the physical memory with a relatively small capacity that is not allocated.

The various non-restrictive implementations of the present application are described in detail below with reference to the drawings.

### Exemplary method

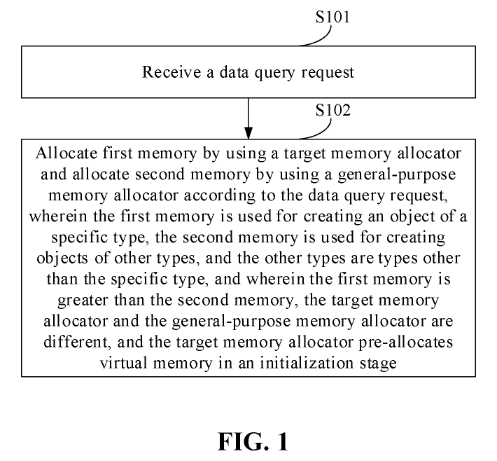

Referring to FIG. 1, FIG. 1 is a flowchart of a memory allocation method in data query according to an embodiment of the present application. The solution provided by the embodiments of the present application may be applied to a server, and the server may be, for example, a server integrated with a database or a server integrated with a database function.

In the embodiment of the present application, the method may include the following steps: S101-S102.

S101: receiving a data query request.

In an example, the data query request sent by another device, such as another server or a client, may be received, wherein the data query request is used to query target data from a database. The data query request is not specifically limited in the embodiment of the present application, and the data query request may be, for example, a structured query language (structured query language, SQL) statement.

S102: allocating first memory by using a target memory allocator and allocating second memory by using a general-purpose memory allocator according to the data query request, wherein the first memory is used for creating an object of a specific type, the second memory is used for creating objects of other types, and the other types are types other than the specific type, wherein the first memory is greater than the second memory, the target memory allocator and the general-purpose memory allocator are different, and the target memory allocator pre-allocates memory at an initialization stage.

After receiving the data query request, the server may process the data query request to query the target data queried by the data query request from the database.

In the present application, processing the data query request requires occupying a certain memory. Therefore, before processing the data query request, it is necessary to allocate a memory for the data query request. In a specific example, processing the data query request requires creating a plurality of objects in the memory, wherein the plurality of objects include an object of a specific type and objects of other types other than the specific type.

In the present application, the memory required to be occupied by the object of the specific type is greater than the memory required to be occupied by the objects of the other types. Alternatively, the object of the specific type needs to occupy a large memory, and the objects of the other types need to occupy a relatively small memory.

In an example, considering that a hash table (HashTable) is a basic data structure for join and aggregation calculation, and the corresponding memory application and release are very intensive, creating a hash table requires occupying a relatively large memory, and moreover, the influence on the query performance of the database is also very important. Therefore, in an example, the object of the specific type includes a hash table.

In another example, considering that a data structure including a linked list needs to occupy a plurality of pieces of relatively large (e.g., 4k) memory, in an example, the object of the specific type includes the above data structure including the linked list. The data structure including the linked list mentioned here may be, for example, Arena. Arena is similar to a memory pool (Memory Pool). It avoids frequent memory application and release caused by temporary objects by applying for a large block of memory, and is mainly used to store intermediate results of a function or intermediate results of Aggregation.

In another example, considering that a plain of data array (POD Array) also needs to frequently apply for and release a large memory in the calculation process, in an example, the object of the specific type includes the plain of data array. The plain of data array may include three categories:

The first category is a basic data type including a numeric type and a character type. Where:

The numeric type may include an integer type (int, short, long, etc.), a floating point type (float, double, etc.). These types occupy a fixed size in the memory and have a clear range of numerical representation. For example, an int type usually occupies 4 bytes and can represent a numerical range from -2147483648 to 2147483647.

The character type includes, for example, a char type, which is used to represent a single character. In some systems, the char type may be signed or unsigned, depending on the compiler and the platform.

The second category is a simple structure type. The simple structure type includes: a structure whose members are POD types, and a structure without special member functions. Where:

If all members of a structure are POD types, the structure itself is also a POD type. For example: struct Point {int x; int y;}; the structure contains two integer members, both of which are POD types, so Point is also a POD type. The memory layout of such a structure is continuous, and the members are stored in the memory in the order of declaration. The object of such a structure may be copied through a simple memory copy operation.

If a structure does not contain a user-defined constructor, destructor, copy assignment operator, and other special member functions, and has no virtual function and virtual base class, it may also be a POD type. For example, struct SimpleStruct {int a; float b;}; this structure does not have any special member functions, so it is a POD type.

The third category is an array type. The array type includes an array of basic data types and an array of POD type structures. The array composed of basic data types is a POD type. For example, int arr ; this integer array is a POD type because its element type int is a POD type, and the memory layout of the array is continuous. If the element type of an array is a POD type structure, the array is also a POD type. For example, struct Point points [5]; the points array here is a POD type because the Point structure is a POD type.

In the present application, the above objects of the other types include other objects other than the hash table, the plain of data array, and the data structure including the linked list. As a specific example, the objects of the other types include one or more of the following: a pipeline executor (PipelineExecutor), a thread pool (ThreadPool), a data column (Column), a string (String), a vector (vector), or a map (map). PipelineExecutor, ThreadPool, Column, String, vector, and map are all basic concepts in computer software, which will not be described in detail here.

Considering that the object of the specific type needs to occupy a large memory, while the general-purpose memory allocator (such as the aforementioned Jemalloc or Tcmalloc) has poor performance in allocating a large memory, in the present application, instead of using the general-purpose memory allocator to allocate the memory for the object of the specific type, a target memory allocator different from the general-purpose memory allocator is used to allocate the memory for the object of the specific type. Specifically, the first memory may be allocated by using the target memory allocator, wherein the first memory is used to create the above object of the specific type.

In the present application, the target memory allocator pre-allocates the virtual memory at the initialization stage. When allocating the first memory, the target memory allocator may first allocate the target virtual memory from the pre-allocated virtual memory, and then allocate the first memory based on the target virtual memory. Specifically, the physical memory may be mapped to the target virtual memory, and accordingly, the physical memory mapped to the target virtual memory is the first memory allocated by the target memory allocator for the object of the specific type.

It is precisely because the target memory allocator pre-allocates the virtual memory at the initialization stage, when allocating the first memory, the target memory allocator may directly allocate the target virtual memory from the pre-allocated virtual memory, thereby effectively reducing the page fault corresponding to the virtual memory and effectively reducing the TLB miss.

In an example, after pre-allocating the virtual memory, the virtual memory may be segmented to obtain a page corresponding to the virtual memory. As an example, if the kernel version of the server is relatively high and supports the huge page (huge_page) technology, the pre-allocated virtual memory may be segmented by using the huge_page technology to obtain the page corresponding to the virtual memory. For example, the madvise function may be used to start the huge_page technology to segment the pre-allocated virtual memory by using the huge_page technology to obtain the page corresponding to the virtual memory. In this scenario, compared with the case where the huge_page technology is not applied, the greater the capacity of the virtual memory corresponding to one page is, the smaller the possibility of generating a page fault when allocating the first memory is, and accordingly, the better the effect of reducing the TLB miss is. As another example, if the kernel version of the server is not high and does not support the huge_page technology, the page corresponding to the virtual memory may also be obtained by segmenting the pre-allocated virtual memory in a conventional manner.

In the present application, the server that executes the solution provided by the embodiments of the present application may be integrated with a memory allocation service, and the memory allocation service is used to provide the memory allocation function provided by the aforementioned target memory allocator. In this scenario, the aforementioned general-purpose memory allocator pre-allocates the virtual memory at the initialization stage, which may be that the memory allocation service pre-allocates the virtual memory at the initialization stage. Specifically, the memory allocation service may be initialized when the server is started. Initializing the memory allocation service includes performing at least one initialization operation of the memory allocation service, wherein the at least one initialization operation includes: compiling the memory allocation service. Accordingly, the aforementioned operation of pre-allocating the virtual memory may be performed when the memory allocation service is compiled. In other words, the server may allocate the virtual memory for the target memory allocator when the memory allocation service is in the compilation stage, so as to subsequently allocate the first memory based on the pre-allocated virtual memory.

In addition, considering that for the aforementioned objects of the other types, they occupy a relatively small memory, while the general-purpose memory allocator has good performance in allocating a relatively small memory, therefore, the general-purpose memory allocator may be used to allocate the memory for the objects of the other types. Specifically, the second memory may be allocated by using the general-purpose memory allocator, wherein the second memory is used to create the aforementioned objects of the other types. The second memory is less than the first memory.

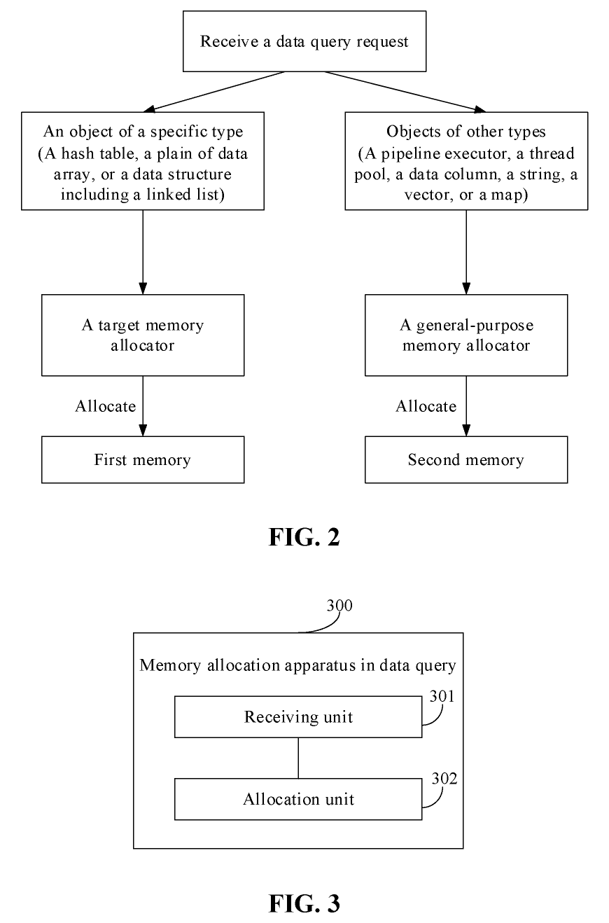

Reference may be made to FIG. 2 for understanding. FIG. 2 is a flowchart of a memory allocation method according to an embodiment of the present application. As shown in FIG. 2, after the data query request is received, the first memory is allocated by using the target memory allocator for the hash table, the plain of data array, and the data structure including the linked list, and the second memory is allocated by using the general-purpose memory allocator for one or more of the following objects: the pipeline executor, the thread pool, the data column, the string, the vector, or the map.

It can be seen from the above description that by using the solution provided by the embodiment of the present application, for the object occupying a relatively small memory (that is, the objects of the other types), the general-purpose memory allocator is used to allocate the second memory so as to subsequently create the object occupying the relatively small memory based on the second memory. For the object occupying a relatively large memory (that is, the object of the specific type), instead of using the general-purpose memory allocator to allocate the memory, the target memory allocator is used to allocate the first memory so as to subsequently create the object of the specific type based on the first memory. The target memory allocator pre-allocates the virtual memory at the initialization stage. Therefore, allocating the first memory based on the target memory allocator can effectively reduce the page fault and the TLB miss.

Moreover, in the prior art, whether the memory is large or small, the memory is allocated by the general-purpose memory allocator, which easily causes memory fragmentation. In the solution, the large memory is allocated by the target memory allocator that allocates the first memory based on the pre-allocated virtual memory, which will not cause memory fragmentation. The relatively small memory is allocated by the general-purpose memory allocator, which greatly reduces the memory fragmentation compared with the case where both the large memory and the small memory are allocated by the general-purpose memory allocator. That is, by using the solution, the memory fragmentation can also be effectively reduced.

In conclusion, by using the solution of the embodiment of the present application, the performance of memory allocation can be effectively improved.

### Exemplary device

Based on the method provided in the above embodiments, an embodiment of the present application further provides an apparatus, and the apparatus is introduced below with reference to the drawings.

Referring to FIG. 3, FIG. 3 is a schematic diagram of a structure of a memory allocation apparatus in data query according to an embodiment of the present application. The apparatus 300 shown in FIG. 3 is configured to perform the memory allocation method in data query provided in the above method embodiments.

The apparatus 300 may specifically include, for example, a receiving unit 301 and an allocating unit 302.

The receiving unit 301 is configured to receive a data query request.

The allocating unit 302 is configured to allocate first memory by using a target memory allocator and allocate second memory by using a general-purpose memory allocator according to the data query request, wherein the first memory is used for creating an object of a specific type, the second memory is used for creating objects of other types, and the other types are types other than the specific type; where:

the first memory is greater than the second memory, the target memory allocator and the general-purpose memory allocator are different, and the target memory allocator pre-allocates virtual memory at an initialization stage.

Optionally, the allocating unit 302 is configured to: allocate target virtual memory from the pre-allocated virtual memory; allocate the first memory based on the target virtual memory.

Optionally, the apparatus is applied to a server, the server is integrated with a memory allocation service, and the apparatus further includes an initializing unit, configured to initialize the memory allocation service in response to the server being started, wherein initializing the memory allocation service includes: compiling the memory allocation service, and allocating the virtual memory for the target memory allocator when the memory allocation service is in a compilation stage.

Optionally, the object of the specific type includes one or more of the following: a hash table, a plain of data array, or a data structure including a linked list.

Optionally, the objects of the other types include one or more of the following: a pipeline executor, a thread pool, a data column, a string, a vector, or a map.

Optionally, a page corresponding to the virtual memory is obtained by segmenting the virtual memory by using a huge page technology.

Optionally, the general-purpose memory allocator includes: Jemalloc or Tcmalloc.

Since the apparatus 200 is an apparatus corresponding to the image processing method provided in the above method embodiments, the specific implementations of the units of the apparatus 200 are the same as those of the above method embodiments, and therefore, reference may be made to the relevant description of the above method embodiments for the specific implementations of the units of the apparatus 200, which will not be repeated here.

An embodiment of the present application further provides a device, the device including a processor and a memory; the processor is configured to execute instructions stored in the memory to cause the device to perform the method according to any one of the above method embodiments.

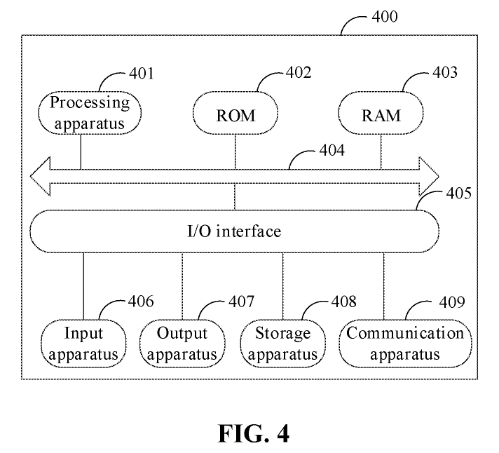

Referring to FIG. 4 below, it illustrates a schematic diagram of a structure of an electronic device 400 suitable for implementing the embodiments of the present application. The electronic device in the embodiments of the present application may include, but is not limited to, mobile terminals such as a mobile phone, a notebook computer, a digital broadcast receiver, a personal digital assistant (PDA), a tablet computer, a portable media player (PMP), and an in-vehicle terminal (such as an in-vehicle navigation terminal), and fixed terminals such as a digital TV (television) and a desktop computer. The electronic device shown in FIG. 4 is merely an example and should not impose any limitation to the function and scope of use of the embodiments of the present application.

As shown in FIG. 4, the electronic device 400 may include a processing apparatus (such as a central processing unit and a graphics processing unit) 401. The processing apparatus 401 may perform various appropriate actions and processing according to a program stored in a read-only memory (ROM) 402 or a program loaded from a storage apparatus 408 into a random access memory (RAM) 403. Various programs and data required for the operation of the electronic device 400 are also stored in the RAM 403. The processing apparatus 401, the ROM 402, and the RAM 403 are connected to each other through a bus 404. An input/output (I/O) interface 405 is also connected to the bus 404.

Generally, the following apparatuses may be connected to the I/O interface 405: an input apparatus 406 including, for example, a touchscreen, a touchpad, a keyboard, a mouse, a camera, a microphone, an accelerometer, a gyroscope, etc.; an output apparatus 407 including, for example, a liquid crystal display (LCD), a speaker, a vibrator, etc.; a storage apparatus 408 including, for example, a magnetic tape, a hard disk, etc.; and a communication apparatus 409. The communication apparatus 409 may allow the electronic device 400 to perform wireless or wired communication with other devices to exchange data. Although FIG. 4 shows the electronic device 400 having various apparatuses, it should be understood that it is not required to implement or have all of the illustrated apparatuses. More or fewer apparatuses may alternatively be implemented or provided.

In particular, according to the embodiments of the present application, the processes described above with reference to the flowcharts may be implemented as a computer software program. For example, the embodiments of the present application include a computer program product, which includes a computer program carried on a non-transitory computer-readable medium. The computer program includes program codes for executing the method shown in the flowcharts. In such an embodiment, the computer program may be downloaded and installed from the network through the communication apparatus 409, or may be installed from the storage apparatus 408, or may be installed from the ROM 402. When the computer program is executed by the processing apparatus 401, the above functions defined in the method of the embodiments of the present application are executed.

The electronic device provided in the embodiment of the present application belongs to the same inventive concept as the method provided in the above embodiments. For the technical details not described in detail in this embodiment, reference may be made to the above embodiments, and this embodiment has the same beneficial effects as the above embodiments.

An embodiment of the present application provides a computer-readable medium having a computer program stored thereon, wherein when the program is executed by a processor, the method according to any one of the above embodiments is implemented.

It should be noted that the computer-readable medium described above in the present application may be a computer-readable signal medium or a computer-readable storage medium, or any combination thereof. The computer-readable storage medium may be, for example, but not limited to, an electronic, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present application, the computer-readable storage medium may be any tangible medium that contains or stores a program, and the program may be used by or in conjunction with an instruction execution system, apparatus, or device. In the present application, the computer-readable signal medium may include a data signal propagated in a baseband or as a part of a carrier, in which computer-readable program codes are carried. This propagated data signal may take a variety of forms, including, but not limited to, an electromagnetic signal, an optical signal, or any suitable combination thereof. The computer-readable signal medium may also be any computer-readable medium other than the computer-readable storage medium. The computer-readable signal medium may send, propagate, or transmit a program used by or in conjunction with an instruction execution system, apparatus, or device. The program codes contained on the computer-readable medium may be transmitted by any suitable medium, including, but not limited to, a wire, an optical cable, radio frequency (RF), etc., or any suitable combination thereof.

In some implementations, clients and servers may communicate using any currently known or future developed network protocol, such as the HyperText Transfer Protocol (HTTP), and may be interconnected with any form or medium of digital data communication (for example, a communication network). Examples of the communication network include a local area network ("LAN"), a wide area network ("WAN"), the Internet, and a peer-to-peer network (for example, an ad hoc network), as well as any currently known or future developed network.

The above computer-readable medium may be included in the above electronic device, or may exist alone without being assembled into the electronic device.

The above computer-readable medium carries one or more programs which, when executed by the electronic device, cause the electronic device to perform the above method.

The computer program codes for performing the operations of the present application may be written in one or more programming languages or a combination thereof. The above programming languages include object-oriented programming languages such as Java, Smalltalk, and C++, as well as conventional procedural programming languages such as the "C" programming language or similar programming languages. The program codes may be executed entirely on the computer of a user, executed partly on the computer of a user, executed as a stand-alone software package, executed partly on the computer of a user and partly on a remote computer, or executed entirely on a remote computer or a server. In the scenario related to the remote computer, the remote computer may be connected to the computer of the user through any type of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present application. In this regard, each block in the flowcharts or block diagrams may represent a module, a program segment, or a portion of codes, including one or more executable instructions for implementing specified logic functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a special-purpose hardware-based system that performs the specified functions or operations, or may also be implemented by a combination of special-purpose hardware and computer instructions.

The units involved in the embodiments described in the present application may be implemented in software or hardware. The name of the unit/module does not constitute a limitation of the unit per se under certain circumstances. For example, a voice data collection module may also be described as a "data collection module".

The functions described herein above may be executed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present application, a machine-readable medium may be a tangible medium that may include or store a program for use by or in conjunction with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination of the above. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the above.

Other implementations of the present application will be readily apparent to those skilled in the art from consideration of the specification and practice of the invention disclosed herein. This application is intended to cover any variations, uses, or adaptations of the present application, which follow the general principles of the present application and include common general knowledge or conventional technical means in the technical field not disclosed in the present disclosure. The specification and the embodiments are to be considered as exemplary only, while the true scope and spirit of the present application are indicated by the following claims.

It should be understood that the present application is not limited to the precise structures that have been described above and shown in the drawings, and various modifications and changes may be made without departing from the scope thereof. The scope of the present application is limited only by the appended claims.

The above are merely preferred embodiments of the present application and are not intended to limit the present application. Any modification, equivalent replacement, improvement, etc. made within the spirit and principles of the present application shall be included in the protection scope of the present application.

We claim:

1. A memory allocation method in data query comprising:
receiving a data query request; and
allocating first memory by using a target memory allocator and allocating second memory by using a general-purpose memory allocator according to the data query request, wherein the first memory is used for creating an object of a specific type, the second memory is used for creating objects of other types, and the other types are types other than the specific type; wherein:
the first memory is greater than the second memory, the target memory allocator and the general-purpose memory allocator are different, and the target memory allocator pre-allocates virtual memory at an initialization stage.

2. The method according to claim 1, wherein allocating the first memory by using the target memory allocator comprises:
allocating target virtual memory from the pre-allocated virtual memory; and
allocating the first memory based on the target virtual memory.

3. The method according to claim 1, wherein the method is applied to a server, the server is integrated with a memory allocation service, and the method further comprises:
initializing the memory allocation service in response to the server being started, wherein initializing the memory allocation service comprises: compiling the memory allocation service, and allocating the virtual memory for the target memory allocator when the memory allocation service is in a compilation stage.

4. The method according to claim 1, wherein the object of the specific type comprises one or more of the following:
a hash table, a plain of data array, or a data structure comprising a linked list.

5. The method according to claim 1, wherein the objects of the other types comprise one or more of the following:
a pipeline executor, a thread pool, a data column, a string, a vector, or a map.

6. The method according to claim 1, wherein a page corresponding to the virtual memory is obtained by segmenting the virtual memory by using a huge page technology.

7. The method according to claim 1, wherein the general-purpose memory allocator comprises:
Jemalloc or Tcmalloc.

8. An electronic device comprising a processor and a memory, wherein:
the processor is configured to execute instructions stored in the memory to cause the electronic device to perform a memory allocation method in data query comprising:
receiving a data query request; and
allocating first memory by using a target memory allocator and allocating second memory by using a general-purpose memory allocator according to the data query request, wherein the first memory is used for creating an object of a specific type, the second memory is used for creating objects of other types, and the other types are types other than the specific type; wherein:
the first memory is greater than the second memory, the target memory allocator and the general-purpose memory allocator are different, and the target memory allocator pre-allocates virtual memory at an initialization stage.

9. The electronic device according to claim 8, wherein allocating the first memory by using the target memory allocator comprises:
allocating target virtual memory from the pre-allocated virtual memory; and
allocating the first memory based on the target virtual memory.

10. The electronic device according to claim 8, wherein the method is applied to a server, the server is integrated with a memory allocation service, and the method further comprises:
initializing the memory allocation service in response to the server being started, wherein initializing the memory allocation service comprises: compiling the memory allocation service, and allocating the virtual memory for the target memory allocator when the memory allocation service is in a compilation stage.

11. The electronic device according to claim 8, wherein the object of the specific type comprises one or more of the following:
a hash table, a plain of data array, or a data structure comprising a linked list.

12. The electronic device according to claim 8, wherein the objects of the other types comprise one or more of the following:
a pipeline executor, a thread pool, a data column, a string, a vector, or a map.

13. The electronic device according to claim 8, wherein a page corresponding to the virtual memory is obtained by segmenting the virtual memory by using a huge page technology.

14. The electronic device according to claim 8, wherein the general-purpose memory allocator comprises:
Jemalloc or Tcmalloc.

15. A non-transitory computer-readable storage medium comprising instructions, wherein the instructions instruct a device to perform a memory allocation method in data query comprising:
receiving a data query request; and
allocating first memory by using a target memory allocator and allocating second memory by using a general-purpose memory allocator according to the data query request, wherein the first memory is used for creating an object of a specific type, the second memory is used for creating objects of other types, and the other types are types other than the specific type; wherein:
the first memory is greater than the second memory, the target memory allocator and the general-purpose memory allocator are different, and the target memory allocator pre-allocates virtual memory at an initialization stage.

16. The non-transitory computer-readable storage medium according to claim 15, wherein allocating the first memory by using the target memory allocator comprises:
allocating target virtual memory from the pre-allocated virtual memory; and
allocating the first memory based on the target virtual memory.

17. The non-transitory computer-readable storage medium according to claim 15, wherein the method is applied to a server, the server is integrated with a memory allocation service, and the method further comprises:
initializing the memory allocation service in response to the server being started, wherein initializing the memory allocation service comprises: compiling the memory allocation service, and allocating the virtual memory for the target memory allocator when the memory allocation service is in a compilation stage.

18. The non-transitory computer-readable storage medium according to claim 15, wherein the object of the specific type comprises one or more of the following:
a hash table, a plain of data array, or a data structure comprising a linked list.

19. The non-transitory computer-readable storage medium according to claim 15, wherein the objects of the other types comprise one or more of the following:
a pipeline executor, a thread pool, a data column, a string, a vector, or a map.

20. The non-transitory computer-readable storage medium according to claim 15, wherein a page corresponding to the virtual memory is obtained by segmenting the virtual memory by using a huge page technology.
